(19) United States
(12) Patent Application Publication
(10) Pub. No.: US 2023/0224867 A1
(43) Pub. Date: Jul. 13, 2023

(54) TECHNOLOGIES FOR INTER-USER EQUIPMENT COORDINATION

(71) Applicant: Apple Inc., Cupertino, CA (US)

(72) Inventors: Zhibin Wu, Los Altos, CA (US); Chunxuan Ye, San Diego, CA (US); Haijing Hu, Los Gatos, CA (US); Naveen Kumar R. Palle Venkata, San Diego, CA (US); Pavan Nuggehalli, San Carlos, CA (US); Sethuraman Gurumoorthy, San Ramon, CA (US)

(73) Assignee: Apple Inc., Cupertino, CA (US)

(21) Appl. No.: 18/083,360

(22) Filed: Dec. 16, 2022

Related U.S. Application Data
(60) Provisional application No. 63/297,607, filed on Jan. 7, 2022.

(51) Int. Cl. H04W 72/02; H04W 72/25; H04L 1/1812

(52) U.S. Cl. CPC H04W 72/02; H04W 72/25; H04L 1/1812

(57) ABSTRACT

The present application relates to devices and components including apparatus, systems, and methods for inter-user equipment coordination.

### CROSS-REFERENCE TO RELATED APPLICATION

This application claims the benefit of U.S. Provisional Patent Application No. 63/297,607, filed on Jan. 7, 2022, which is herein incorporated by reference in its entirety for all purposes.

### TECHNICAL FIELD

The present disclosure relates to the field of wireless networks and, in particular, to technologies for inter-user equipment coordination.

### BACKGROUND

Third Generation Partnership Project (3GPP) provides mechanisms for two or more user equipments (UEs) to communicate with one another over sidelink interfaces. Further study on enhancing resource allocation to facilitate sidelink communications is needed.

### BRIEF DESCRIPTION OF THE DRAWINGS

FIG. 1 illustrates a network environment in accordance with some aspects.

FIG. 2 illustrates a node map in accordance with some aspects.

FIG. 3 illustrates a signaling diagram in accordance with some aspects.

FIG. 4 illustrates another signaling diagram in accordance with some aspects.

FIG. 5 illustrates another signaling diagram in accordance with some aspects.

FIG. 6 illustrates an operational flow/algorithmic structure in accordance with some aspects.

FIG. 7 illustrates another operational flow/algorithmic structure in accordance with some aspects.

FIG. 8 illustrates another operational flow/algorithmic structure in accordance with some aspects.

FIG. 9 illustrates a user equipment in accordance with some aspects.

FIG. 10 illustrates a base station in accordance with some aspects.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various aspects. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrases “A or B” and “A/B” mean (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group), memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP) configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, or network interface cards.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

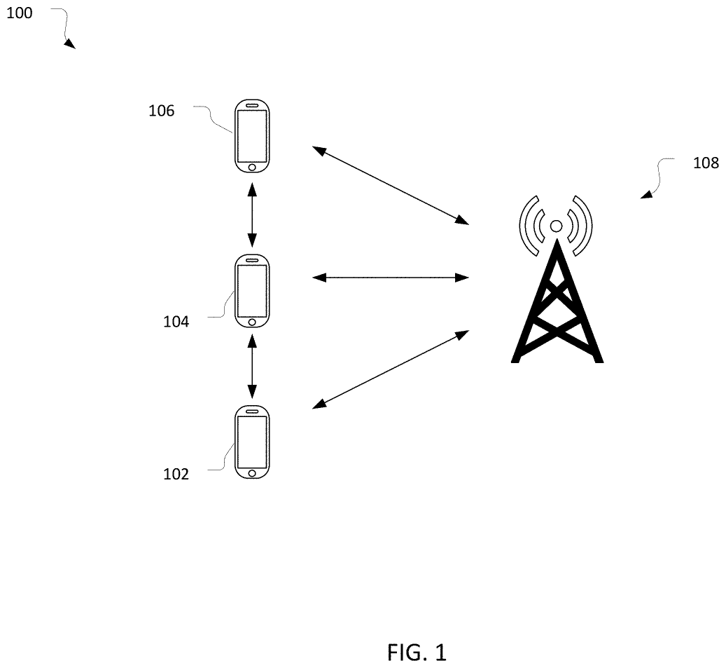

FIG. 1 illustrates a network environment 100 in accordance with some aspects. The network environment 100 may include UEs 102, 104, and 106, and a base station 108. The base station 108 may provide a wireless access cell through which one or more of the UEs 102/104/106 may communicate with the base station 108. In some aspects, the base station 108 is a next generation node B (gNB) that provides a 3GPP New Radio (NR) cell. The air interfaces over which the UEs 102/104/106 and base station 108 communicate may be compatible with 3GPP technical specifications (TSs) such as those that define Fifth Generation (5G) NR system standards.

The UEs 102/104/106 may also communicate directly with one another over a sidelink interface. The sidelink interface may alternatively be referred to as a ProSe interface, device-to-device (D2D) interface, or a PC5 interface or reference point.

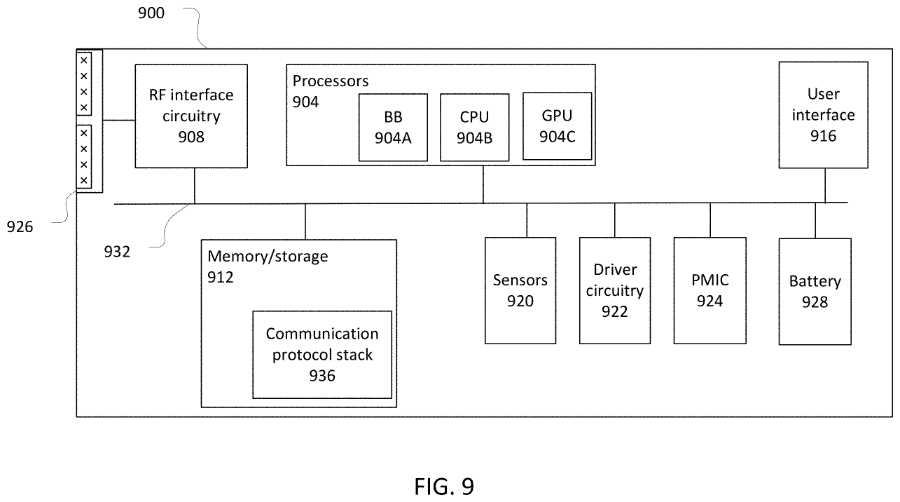

While FIG. 1 depicts the UEs 102/104/106 as mobile phones, the UEs 102/104/106 may be any type of user equipment such as those described below with respect to UE 900 of FIG. 9.

The UEs 102/104/106 may communicate with one another using a sidelink resource pool. In some embodiments, the base station 108 may configure the UEs 102/104/106 with one or more sidelink resource pools by broadcasting system information in a system information block (SIB) message. In some embodiments, the base station 108 may configure the UEs 102/104/106 with one or more sidelink resource pools using dedicated RRC signaling.

The sidelink resource pool may include a set of time/frequency resources for sidelink transmission or reception. The sidelink resource pool may be used for all unicast, groupcast, or broadcast communications for a given UE engaging in sidelink communications. In the frequency domain, the resource pool may include a plurality of subchannels, with each subchannel including a plurality of physical resource blocks (PRBs). In various aspects, a subchannel may include 10, 12, 15, 20, 25, 50, 75, or 100 PRBs, for example. In some aspects, the PRBs of a subchannel, and the subchannels of a resource pool may be contiguous.

In the time domain, a sidelink resource pool may include a plurality of slots, which may be contiguous or noncontiguous. In some aspects, the slots for a sidelink resource pool may be configured by, for example, a bitmap transmitted by the base station 108 to indicate which slots are part of a sidelink resource pool. The bitmap may have a periodicity of 10,240 milliseconds (ms) and a bitmap length between 10-160. In some aspects, a physical slot may include all slots including non-sidelink slots, while a logical slot may only include slots in the resource pool. For example, consider a 10-bit bitmap as follows: [1, 1, 0, 1, 1, 0, 1, 1, 1, 1]. This bitmap indicates that 10 physical slots include 8 logical slots of a sidelink resource pool.

In other aspects, the sidelink resource pool may include time or frequency domains of other sizes.

Resources of the sidelink may be allocated in a number of ways. For example, in a first mode (mode 1), the base station 108 may provide a sidelink grant to a UE. In a second mode (mode 2), a UE may sense a sidelink channel and select its own resources from the sidelink resource pool for transmission.

In mode-2 operation, a transmitting UE may perform a sensing operation within a sensing window. The sensing operation may include decoding sidelink control information (SCI) to determine a data priority indication and resource reservation information from other UEs. The SCI may indicate future resources that are to be used by other UEs for retransmissions or initial transmissions of period new data. The sensing operation may also include measuring energy of the resources to determine a channel quality metric such as, for example, reference signal received power (RSRP). The sidelink RSRP measurement may be based on physical sidelink control channel (PSCCH) demodulation reference signal (DMRS) or physical sidelink shared channel (PSSCH) DMRS.

Based on the sensing operation, the UE will select resources from within a resource selection window. The resources may be selected with a subchannel granularity in the frequency domain and a slot granularity in the time domain. The UE may identify candidate resources within the resource selection window. A resource of the resource selection window may be excluded from the candidate resources if it is reserved or its associated RSRP measurement is above a predetermined threshold. The UE may then select resources from the identified candidate resources. In some aspects, the selection may be randomized. The transmitting UE may then encode the sidelink data on the selected resources for transmission.

While the sensing operation may prevent some future resource overlap from occurring, the sensing may miss aperiodic traffic. Further, the effectiveness of the sensing operation may also be compromised by other issues such as, for example, hidden-node or half-duplex issues.

A hidden node issue may occur if UE 106 is transmitting to UE 104, but is unable to sense resource reservations from UE 102, which may be considered as “hidden” from UE 106. The hidden node issue may be at least partially avoided by relying on additional inter-node alerts after checking SCI reservations.

A half-duplex issue may occur if UE 106 transmits a transport block (TB) to UE 104 while the UE 104 is transmitting to UE 102 (or base station 108) in the same slot. If the UE 104 is a half-duplex UE, it may not be able to simultaneously transmit/receive in the same slot. The half-duplex issue may be at least partially addressed by determining expected/predicted transmissions by checking the SCI reservations. A UE may prevent a half-duplex conflict from happening by canceling its own transmission or asking a peer UE to cancel its scheduled transmission in the sidelink or the uplink. An expected half-duplex conflict may also be detected and warned of by a third-party UE if a prior reservation is also in a half-duplex conflict.

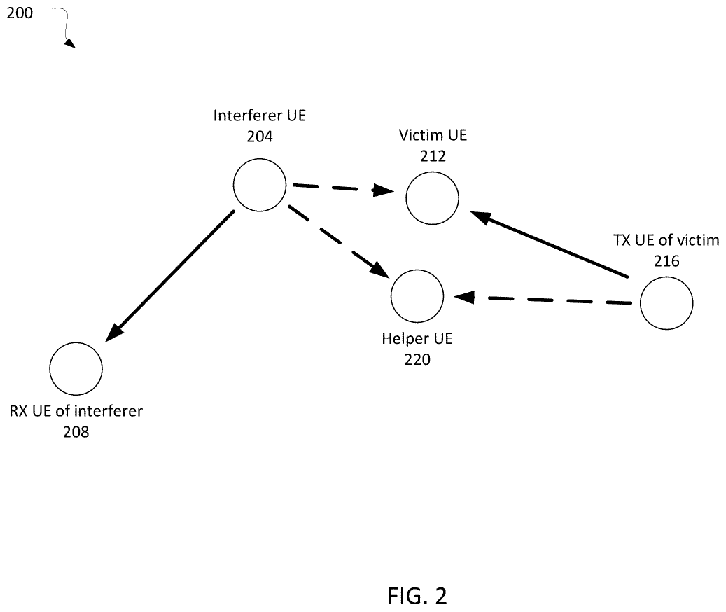

FIG. 2 is a node map 200 illustrating resource conflict and inter-UE coordination (IUC) principles in accordance with some embodiments. The node map 200 illustrates UEs that are engaged in, or otherwise proximate to, sidelink communications. The UEs may be similar to, and substantially interchangeable with, the UEs of the network environment 100.

The node map 200 may include an interferer UE 204, a receive UE of the interferer (RX UE—interferer) 208, a victim UE 212, a transmit UE of the victim (TX UE—victim) 216, and a helper UE 220. The TX UE—victim 216 may be transmitting a sidelink communication to the victim UE 212. The interferer UE 204 may be transmitting a sidelink communication to the RX UE—interferer 208, which results in interference observed by the victim UE 212 and helper UE 220. The helper UE 220 may not be an intended destination of a transmitting UE. Rather, the helper UE 220 may act as a third-party observer that may report on potential reservation conflicts.

The victim/interferer roles of the UEs of the node map 200 may be from the perspective of the victim UE 212. The roles may be changed if viewed from the perspective of another node.

IUC may involve a first UE, referred to herein as UE-A, transmitting IUC information to a second UE, referred to herein as UE-B. The IUC information may include information regarding resource utilization, which helps UE-B to decide the radio resources to select for its future transmissions, or a request/instruction to yield transmissions for the benefit of reducing interference to the victim UE 212.

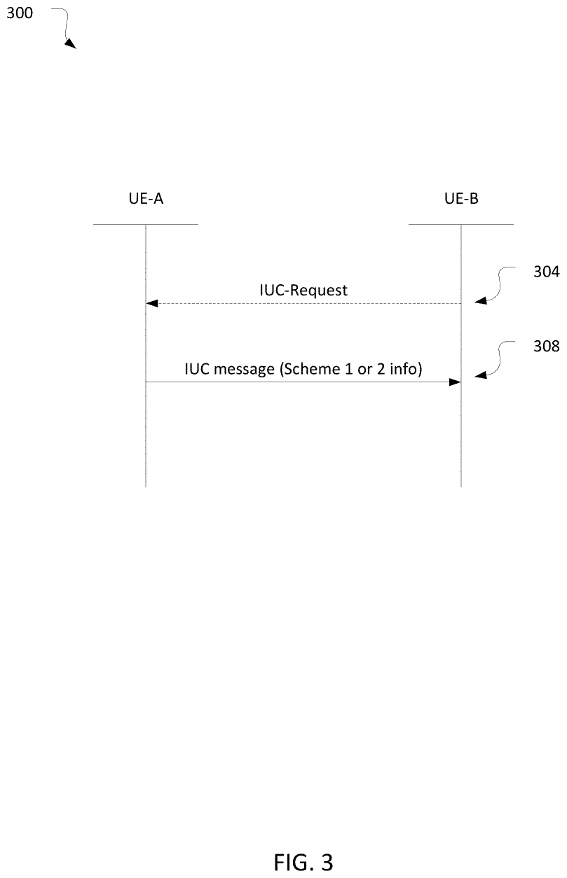

FIG. 3 illustrates a signaling diagram 300 for UE-A and UE-B in accordance with some embodiments. The signaling diagram 300 includes UE-B transmitting an IUC request to UE-A at 304. The IUC request, which is optional, may be a request for the UE-A to send the UE-B IUC information. The IUC request, if present, may be transmitted by SL MAC CE or a PC5 RRC message. The signaling diagram 300 may further include UE-A transmitting an IUC message, including IUC information, to the UE-B at 308. The UE-B may then use the IUC information to assist its resource allocation process to reduce or otherwise mitigate sidelink resource conflict.

Table 1 illustrates roles that UE-A and UE-B may serve in some embodiments.

TABLE 1

| UE-A | UE-B |
|---|---|
| Victim | TX UE-victim |
| Victim | Interferer |
| Helper | Interferer |
| Helper | TX UE-victim |

The IUC information of the IUC message may indicate sidelink resources based on IUC scheme 1 or 2 in order to address hidden-node and half-duplex issues in accordance with some embodiments.

Scheme 1 may be a proactive scheme that uses a combination of higher-layer signaling and lower-layer signaling to provide an indication of sidelink resources. The higher-layer signaling may include media access control (MAC)-control element (CE) or RRC signaling. The lower-layer signaling may include SCI (for example, second stage SCI transmitted by the physical sidelink shared channel (PSSCH)).

In a first option of scheme 1, which may be referred to as option A, the signaling may be used to indicate preferred sidelink resources. For example, UE-A may transmit the IUC information to indicate a set of sidelink resources that the UE-B is to use for sidelink communications. The UE-A may identify the preferred resources by excluding reserved resources, which may be referred to as scheme 1-A-1. Additionally/alternatively, the UE-A may identify the preferred resources by excluding half-duplex conflict slots, which may be referred to as scheme 1-A-2.

In a second option of scheme 1, which may be referred to as option B, the signaling may be used to indicate non-preferred sidelink resources. For example, UE-A may transmit the IUC information to indicate a set of sidelink resources that the UE-B should not use for sidelink communications. The UE-A may identify the non-preferred resources based on resource reservation conflicts, which may be referred to as scheme 1-B-1. The non-preferred resources identified based on resource reservation conflicts may be those sidelink resources that are associated with interference over a threshold amount. In a first option of scheme 1-B-1, the UE-A may be a helper or victim UE and may advise the UE-B, which may be a TX UE—victim UE, to yield the indicated resources. In a second option of scheme 1-B-1, the UE-A may be a victim UE and may advise UE-B, which may be an interferer UE, to yield the indicated resources.

The UE-A may additionally/alternatively identify the non-preferred resources based on half-duplex conflicts, which may be referred to as scheme 1-B-2. Upon identifying the half-duplex conflict, the UE-A, which may be the victim UE, may ask the TX UE— victim to yield the indicated resources.

Scheme 2 may be a reactive scheme that uses lower-layer signaling (for example, physical (PHY) layer solutions) to indicate sidelink resources. The indicated sidelink resources may be non-preferred resources. The PHY layer solutions for collision avoidance include the use of physical sidelink feedback channel (PSFCH) signals to alert a transmitting UE of the possible collision.

The UE-A may identify the non-preferred resources based on resource reservation collisions, which may be referred to as scheme 2-A-1. In scheme 2-A-1, the UE-A, which may be the victim UE, may compare a reference signal receive power (RSRP) of the sidelink resources to a predetermined threshold. In the hidden terminal case, the UE-A may observe two transmissions, which both reserve the same or overlapping future resources. In a first option, the UE-A may compare an RSRP measured on one of these transmissions to an absolute RSRP threshold. In a second option, the UE-A may determine a relative RSRP that is a difference between the RSRPs of the two transmissions and compare the difference to a relative RSRP threshold. The UE-A may use either of these comparisons to determine whether the resources are non-preferred. Upon identifying non-preferred resources, the UE-A may advise UE-B to yield the indicated resources. If UE-A is the victim UE, UE-B may be the TX UE—victim, which may be referred to as case 1, or the interferer UE, which may be referred to as case 2.

Additionally/alternatively, the UE-A may identify the non-preferred resources based on half-duplex conflicts, which may be referred to as option 2-A-2. Upon identifying the half-duplex conflict, the UE-A, which may be the victim UE, may ask the TX UE—victim to yield the indicated resources.

A mode-2 UE has a number of choices of IUC report types it may use. Table 2 illustrates some report types and associated IUC schemes that may be used with each.

TABLE 2

| | 1-A | | 1-B | | 2-A | |
|---|---|---|---|---|---|---|
| Report Types | 1-A-1 | 1-A-2 | 1-B-1 | 1-B-2 | 2-A-1 | 2-A-2 |
| All-inclusive | ✓ | ✓ | ✓ | ✓ | ✓ | ✓ |
| Blacklist-based | | | ✓ | ✓ | ✓ | ✓ |
| Half-duplex only | | | | ✓ | | ✓ |
| Whitelist only | ✓ | ✓ | | | | |
| Scheme 2 only | | | | | ✓ | ✓ |
| Scheme 1 only | ✓ | ✓ | ✓ | ✓ | | |
| Non-preferred | | | ✓ | ✓ | | |
| proactive only | | | | | | |
| Interferer yield + | | | ✓ | ✓ | ✓ | ✓ |
| half duplex | | | (Option 2) | | (Case 2) | |
| Victim → | | | ✓* | | ✓* | |
| transmitter only | | | | | | |

The asterisks shown with respect to the victim->transmitter only report type indicate that a subset of the IUC schemes 1-B-1 and 2-A-1 may be used if the UE is limited to this report type. For example, option 2 of 1-B-1 may not be used in this case because a UE would not ask its own transmitter to yield.

The large number of IUC configurations may result in an excessive amount of signaling to prevent one conciliating transmission. For example, more than one victim or helper UE may act as UE-A to send IUC information to UE-B. In some instances, the IUC signaling may involve false alarms. For example, UE-A may not know whether HARQ feedback is an acknowledgement (ACK) or negative acknowledgement (NACK). Thus, in this situation, the UE-A may assume that the reservations for HARQ retransmissions will be utilized, even if the feedback is actually an ACK and, therefore, no HARQ retransmissions will occur. Still further, periodic reservations may not always match actual traffic demand. Thus, in some instances aggressive reservation of periodic resources may result in reserved, but unused, resources being the basis for IUC messages that cause other UEs to unnecessarily yield resources.

As can be seen, IUC may involve a large number of iterations. At a top-level, IUC may include two schemes, scheme 1 and scheme 2. Each of those schemes may include sub-schemes/options. Each IUC iteration (for example, scheme/sub-scheme/option) may be associated with its own set of pros and cons. Enabling/allowing all of the IUC iterations for sidelink UEs may result in an excessive amount of IUC signaling triggered by the sidelink UEs.

Scheme 1 IUC, with both higher and lower-layer signaling, may be primarily associated with excessive signaling. However, scheme 2 IUC may also face such issues.

The IUC signaling used to address resource collision issues may increase the overhead and result in further collisions, which results in more IUC signaling. This positive feedback loop, if not controlled, may lead to excessive network congestion. Some embodiment describe only enabling/allowing a subset of the IUC iterations schemes/sub-schemes/options in order to achieve a desired balance between overhead and benefits for a particular resource allocation scenario.

To account for the perspective of RRC design, embodiments introduce parameters to control/customize the usage of the various IUC iterations. For example, utilizing IUC to enhance mode-2 resource allocation may not always be needed. If the resources are ample and collisions are rare, it may be desirable for the base station 108 to disable some or all of the IUC iterations.

As IUC messages are intended to help scheduling resource usage for a particular resource pool, some embodiments configure IUC per resource pool. The network may be allowed to configure different IUC iterations for different resource pools. For example, scheme 2 may require the PSFCH resource to be used for conveying IUC information. If a sidelink resource pool does not contain any PSFCH resource configured, then embodiments may enable scheme 1 instead of scheme 2 for that resource pool. If the base station 108 has configured a resource pool with sufficient TX resources, then the benefits of using IUC scheme 1 (scheme 1-A, in particular) may be marginal. So, in this instance, the base station may not configure this resource pool to support IUC scheme 1. To allow for this flexibility, the base station 108 may configure IUC per resource pool. This may be done by RRC signaling. The per-resource pool IUC configurations may be intended for present use by the UEs 102/104/106 or for future use when, for example, the UEs 102/104/106 are out-of-coverage. Unless otherwise specified, “configuration” may refer to either a configuration intended for present use or a configuration intended for future use.

In some embodiments, the UEs 102/104/106 may be preconfigured with IUC information, per-resource pool or otherwise. The preconfiguration may be a configuration provided by the operator when the device is provisioned. Thus, the pre-configuration may not be a real-time configuration by the radio access network. Various embodiments may implement techniques to reduce IUC signaling. These techniques may include one or more of the following eight techniques.

A first technique may disable scheme 1 operation and only allow scheme 2 reactive scheme. This may be similar to the scheme 2 only report type indicated in Table 2.

A second technique may disable preferred resource and only report non-preferred resources (for example, resources that are likely to experience collision). This may include scheme 1-B and scheme 2 operation.

A third technique may only allow half-duplex IUC. This may include schemes 1-A-2, 1-B-2, and 2-A-2. Restricting IUC operation to half-duplex schemes may be beneficial as it only needs to support signaling for one-dimensional resources in the time domain (for example, slots), as opposed to requiring signaling for a two-dimensional time-frequency resource map to describe the sidelink resources.

A fourth technique may only allow a victim UE to transmit an IUC message to its own transmitter to request the transmitter to yield upcoming transmissions. This may include schemes 1-B-1 (option 1), and 2-A-1 (case 1). This technique may be advantageous when there are multiple interferers, which would result in a large number of signaling messages to advise each interferer.

A fifth technique may disable the explicit IUC request. For example, the ability of the UE-B to request IUC information, through IUC-request 304, for example, may be disabled.

A sixth technique may disable an explicit, standalone IUC request. With this technique, an IUC request may be transmitted if it is piggybacked with data transmissions on the sidelink traffic channel (STCH).

A seventh technique may only allow scheme 1 operation to associate with sidelink data transfer.

An eighth technique may only allow IUC-conflict reporting based on resource conflicts detected with at least a threshold confidence level. The threshold confidence level may be 100% sure or something less. For example, the UE-A may transmit IUC information to UE-B based on a conflict associated with a retransmission resource only if it determines that the retransmission resource will actually be used by the transmitter due to detection of a previously transmitted HARQ NACK to this transmitter.

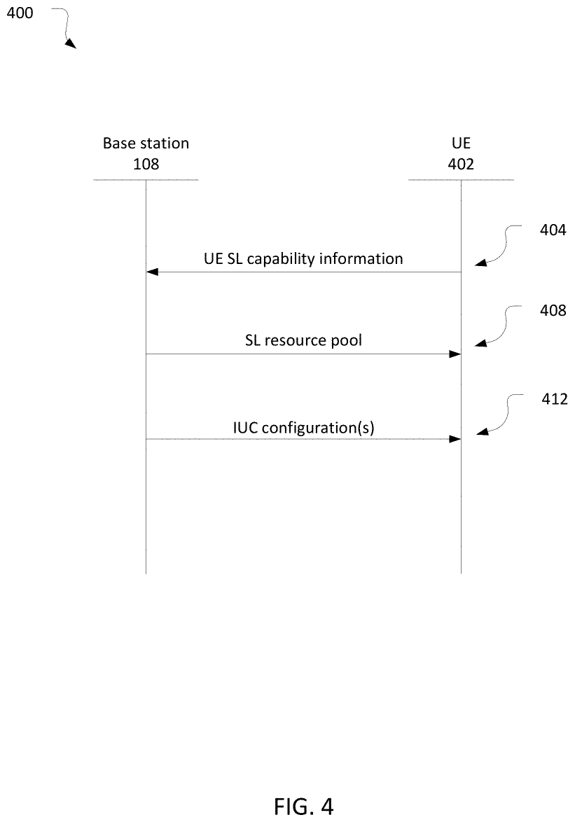

FIG. 4 is a signaling diagram 400 for IUC configurations in accordance with some embodiments. The signaling diagram 400 may be signaling between base station 108 and a UE 402, which may be any UE capable of sidelink communication. The embodiments reflected by the signaling diagram 400 may be used to allow a network to macro-manage overall IUC signaling and obtain a balance between signaling overhead and performance.

At 404, the signaling diagram 400 may include the UE 402 transmitting UE sidelink capability information to the base station 108. The UE sidelink capability information may provide sidelink or IUC capabilities of the UE 402. For example, in some embodiments, the UE capability information may indicate which IUC configurations (for example, reporting types, techniques, or schemes) are supported by the UE 402.

At 408, the signaling diagram 400 may include the base station 108 transmitting an indication of a sidelink resource pool to the UE 402. The transmission may be a unicast transmission (for example, an RRC configuration) or a broadcast transmission (for example, a system information block (SIB) transmission).

At 412, the signaling diagram 400 may include the base station 108 transmitting an indication of one or more IUC configurations to the UE 402. The IUC configurations may be provided per resource pool (as configured at 408). The IUC configurations may have various IUC features that are enabled/disabled.

In some embodiments, the IUC configuration may indicate which scheme/option is allowed or blocked. Additionally/alternatively, the IUC configuration may include trigger conditions that may be used to trigger transmission of an IUC message from UE-A to UE-B. In a first example, a trigger condition may correspond to detecting a resource conflict with at least a threshold confidence level. The threshold confidence level may be 100% or something less. For example, the UE-A may detect a trigger condition and send an IUC message if it predicts a conflict associated with a retransmission resource that it determines will actually be used (based on detection of a previously transmitted HARQ NACK, for example). In a second example, a trigger condition may correspond to prediction of a collision based on a HARQ retransmission. In a third example, a trigger condition may correspond to prediction of a collision based on a periodic transmission. In a fourth example, a trigger condition may correspond to receipt of an IUC request (for example, IUC request 304 of FIG. 3). Thus, in this example, the IUC configuration may indicate whether an explicit IUC request is to be used. One or more of these trigger conditions may be configured. For example, if only one trigger condition is configured, the IUC message may only be transmitted if that particular trigger condition is detected.

In some embodiments, the signaling of 408 and 412 may be combined. For example, the base station 108 may use one SIB to configure both the SL resource pool and the one or more IUC configurations to be used for IUC operations within the resource pool.

The IUC configurations may be set based on the UE sidelink capabilities (transmitted at 404, for example). Additionally/alternatively, the IUC configurations may be set based on UE measurements. The UE measurements may indicate a density of a sidelink channel, a channel busy ratio (CBR), etc.

The UE 402 may be a mode-2 UE. If the mode-2 UE is in an idle or inactive mode, the base station 108 may provide the IUC configurations in a SIB transmission. In some embodiments, the base station 108 may preconfigure the mode-2 UE with the IUC configurations, which may allow the mode-2 UE to use the IUC configuration when out-of-coverage (OOC). In other embodiments, if the mode-2 UE is in an RRC connected state, the base station 108 may provide the IUC configurations using dedicated RRC signaling. This may allow the base station 108 to provide the UE 402 with specific IUC configurations. That is, this may allow per-UE IUC configurations as opposed to per-resource pool IUC configurations.

The per-UE IUC configuration may also be possible using dedicated signaling to mode-1 UEs in the event cross-mode IUC is supported. In cross-mode IUC, a mode-1 UE may act as UE-A to detect a potential conflict and transmit an IUC message to a mode-2 UE that is acting as UE-B. Thus, the mode-1 UE may detect resource conflicts resulting from mode-2 RA even though it does not use mode-2 RA for its own transmissions.

In some embodiments, the UE may provide IUC statistics to the base station 108 to facilitate desired IUC configurations. The IUC statistics may be included in an RRC connected sidelink UE report. The report may be included in a Uu RRC message such as a UE assistance information message or a measurement report. The statistics may include, but are not limited to, a number of detected half-duplex conflicts, a number of detected resource collision conflicts, an average number of neighboring transmissions, a number of detected IUC messages, or an indication of PSFCH usage for scheme 2 IUC reporting. The IUC statistics may be based on a reporting period defined for one or more of the individual statistics.

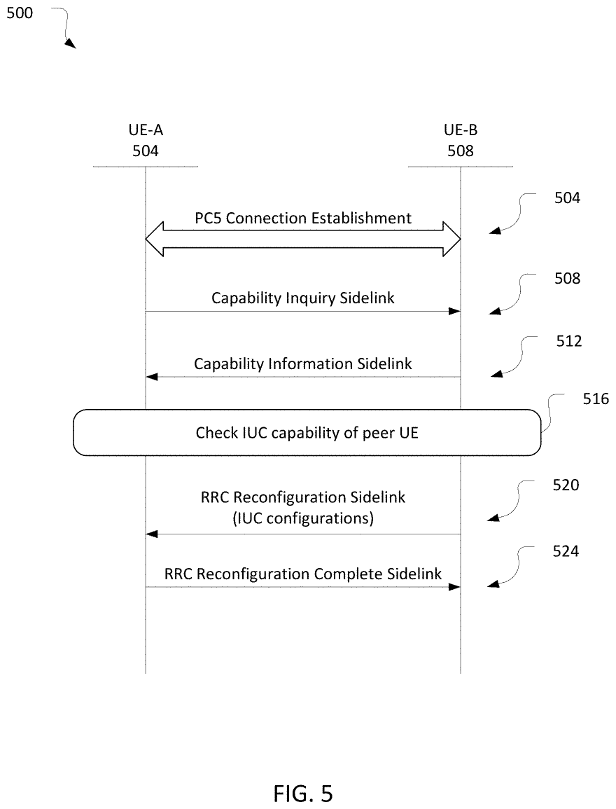

FIG. 5 is a signaling diagram 500 for IUC operation in accordance with some embodiments. The signaling diagram 500 may describe signaling between UE-A 504 and UE-B 508. The embodiments reflected by the signaling diagram 500 may be used for inter-IUC configuration in which UE-B 508 explicitly indicates the type of IUC information requested from the UE-A 504. This request may be based on a mutual understanding of sidelink UE capability.

The signaling diagram 500 may include, at 504, establishing a PC5 connection between the UE-A 504 and the UE-B 508. The PC5 connection may be established in accordance with legacy procedures.

The signaling diagram 500 may further include, at 508, the UE-A 504 transmitting a message including capability inquiry sidelink (CapabilityInquirySidelink) information element to the UE-B 508. This message may request information about sidelink capabilities of the UE-B 508. In some embodiments, this message may also be used to provide the UE-B 508 with information about sidelink capabilities of the UE-A 504. For example, this message may also include a capability information sidelink (CapabilityInfoSidelink) information element.

The signaling diagram 500 may further include, at 512, the UE-B 508 transmitting a message including a capability information sidelink (CapabilityInfoSidelink) information element. This message may provide the requested information about sidelink capabilities of the UE-B 508.

At 516, one or more of the UEs may check the IUC capability of a peer UE based on information exchanged in messages transmitted at 508 and 512.

The signaling diagram 500 may further include, at 520, the UE-B 508 transmitting an IUC configuration message to the UE-A 504. The IUC configuration message may be included as part of an RRC Reconfiguration Sidelink message (as shown) defined in PC5-RRC for all sidelink related configurations between UE-B 508 and UE-A 504. The IUC configuration message may provide an indication of the IUC configurations of the UE-B 508. The IUC configurations indicated in the IUC configuration message may be the IUC configurations that the UE-B 508 prefers the UE-A 504 to use for generating and transmitting IUC messages. For example, the IUC configuration message may request that preferred resources be reported according to scheme 1-A or non-preferred resources be reported according to one or more of scheme 1B or scheme 2. The IUC configuration message may additionally/alternatively provide an indication of one or more trigger conditions that may be used by the UE-A 504 to trigger transmission of an IUC message to UE-B 508.

The IUC configuration message may additionally/alternatively enable/disable one or more IUC operational modes of the UE-A 504. The operational modes may be a victim-victim transmitter (VT) mode in which the UE-A 504 is the victim and UE-B 508 is the TX UE—victim, a victim-interferer mode in which the UE-A 504 is the victim and UE-B 508 is the interferer, a helper-interferer mode in which the UE-A 504 is the helper and the UE-B 508 is the interferer, or a helper-VT mode in which the UE-A 504 is the helper and the UE-B is the TX UE—victim.

The IUC configurations indicated in the IUC configuration message may be selected based on the IUC capabilities of the UE-A 504.

The signaling diagram 500 may further include, at 524, the UE-A 504 transmitting an IUC configuration complete message to the UE-B 508 to acknowledge the IUC configurations. The IUC configuration complete message can be represented by an RRC reconfiguration complete sidelink message (as shown) defined in PC5-RRC.

After completing the configurations, the UEs may generate/process IUC message(s), as shown in FIG. 3, which may include IUC information consistent with one or more of the IUC configurations indicated in the IUC configuration message. The transmission of the IUC message may be triggered by the UE-A 504 detecting a trigger defined by the corresponding IUC configuration.

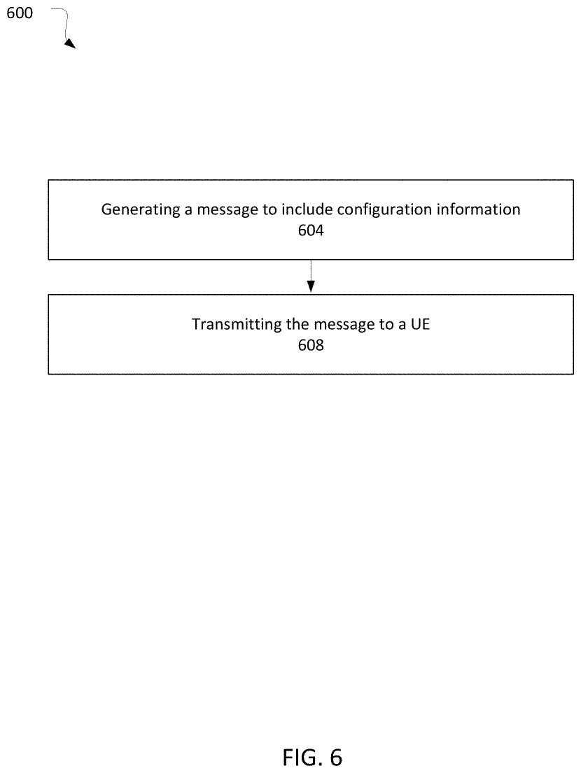

FIGS. 6-8 present a number of operational flows/algorithmic structures in accordance with aspects of this disclosure. These operation flow/algorithmic structures describe a number of operations in a particular sequence. However, the presented sequences are not restrictive. That is, the operations may be performed in sequences other than those specifically presented.

FIG. 6 illustrates an operational flow/algorithmic structure 600 in accordance with some embodiments. The operational flow/algorithmic structure 600 may be performed or implemented by a base station such as base station 108 or 1000; or components thereof, for example, baseband processor 1004A.

The operation flow/algorithmic structure 600 may include, at 604, generating a message to include configuration information to configure a UE with one or more IUC configurations. The IUC configurations may be used to avoid interference over a sidelink resource that would otherwise be experienced by the UE configured with the IUC scheme or another UE.

Configuring the UE with one or more IUC configurations may be accomplished by signaling a set of IUC schemes that are either enabled or disabled. This may also include allowing or blocking certain options of the enabled IUC schemes.

The configuration information may additionally configure at least one trigger for an IUC conflict report. For example, the trigger condition may include detecting a resource conflict with at least a threshold confidence level, or detecting a resource conflict due to a HARQ retransmission or a scheduled periodic transmission.

In some embodiments, the configuration information may be generated by the base station based on an IUC capability of the UE. For example, the base station may only select IUC configurations that are supported by the UE.

The operation flow/algorithmic structure 600 may further include, at 608, transmitting the message to the UE. In some embodiments, the configuration information may be specific to a UE and the message may be transmitted through unicast signaling such as, for example, dedicated RRC signaling. In other embodiments, the configuration information may correspond to a sidelink resource pool and the message may be transmitted through broadcast signaling such as, for example, a SIB transmission.

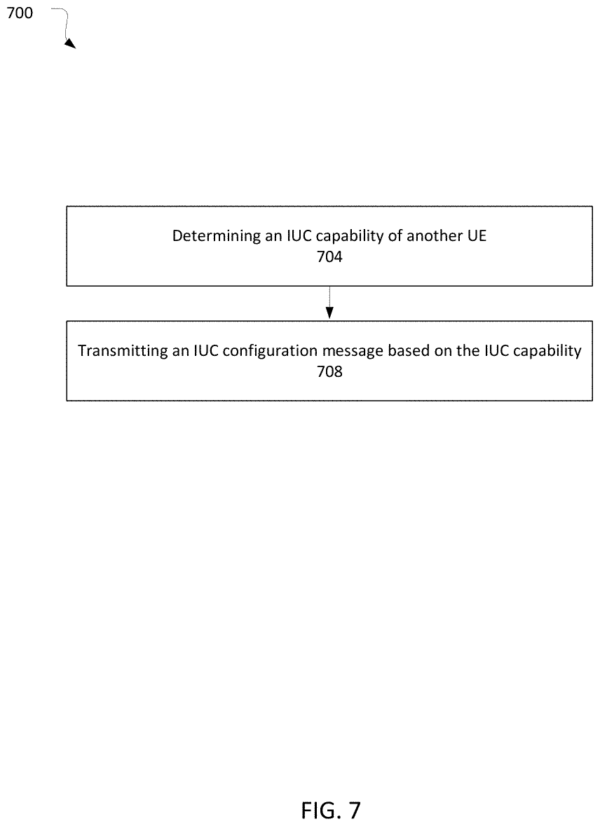

FIG. 7 illustrates an operation flow/algorithmic structure 700 in accordance with some aspects. The operation flow/algorithmic structure 700 may be performed or implemented by a UE-B such as UE 900 or any other of the UEs described herein; or components thereof, for example, baseband processor 904A.

The operation flow/algorithmic structure 700 may include, at 704, determining an IUC capability of another UE, for example, a UE-A. The IUC capability may be an ability to support one or more IUC schemes or options thereof. In some embodiments, the IUC capability may be determined by receiving an IUC capability report from the UE-A. The report may be received in response to a request for IUC capabilities or may be proactively provided by the UE-A.

The operation flow/algorithmic structure 700 may further include, at 708, transmitting an IUC configuration message to the UE-A. The IUC configuration message may include one or more IUC configurations that the UE-B requests the UE-A to use in detecting conflicts and transmitting the UE-B a resulting IUC message. The IUC configuration message may include trigger conditions the UE-A may use to trigger reporting of the IUC message and may additionally/alternatively enable one or more IUC operational modes, which may be based on roles served by the UE-A and the UE-B for IUC purposes.

Thereafter, the UE-B may receive an IUC message, generated in a manner consistent with the signaled IUC configurations, from the UE-A that requests the UE-B yield use of a scheduled sidelink resource.

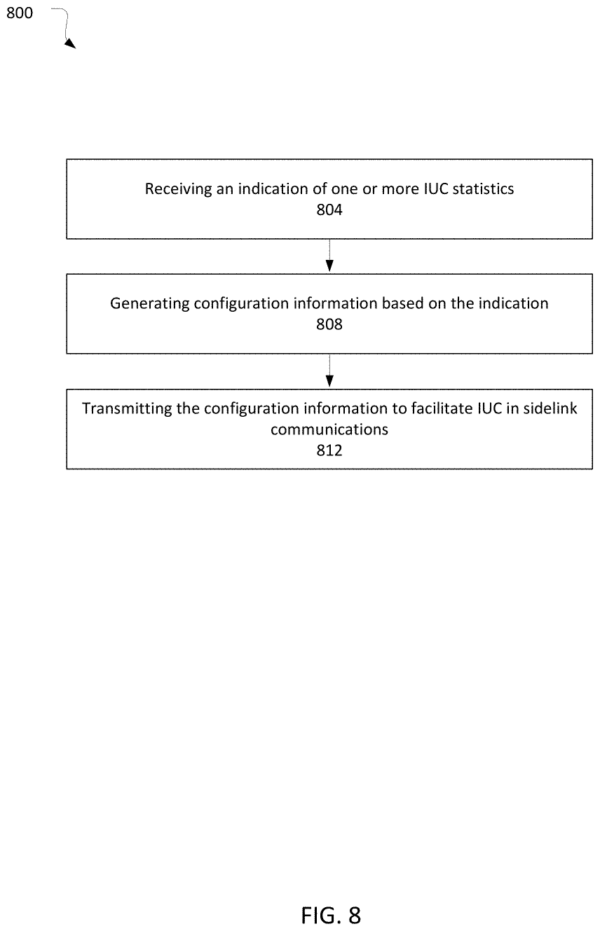

FIG. 8 illustrates an operational flow/algorithmic structure 800 in accordance with some embodiments. The operational flow/algorithmic structure 800 may be performed or implemented by a base station such as base station 108 or 1000; or components thereof, for example, baseband processor 1004A.

The operational flow/algorithmic structure 800 may include, at 804, receiving an indication of one or more IUC statistics. The statistics may include, for example, a number of half-duplex conflicts detected, a number of hidden-node conflicts detected, an average number of neighboring transmissions, a number of IUC messages detected, or an indication of PSFCH usage for IUC information. The statistics may be defined for one or more periods of time and may be associated with various reporting periods.

The operational flow/algorithmic structure 800 may further include, at 808, generating configuration information based on the indication. The base station may use the IUC statistics to effectively increase or decrease IUC signaling in a manner to achieve a desired balance between IUC overhead and performance for a given sidelink environment.

The operational flow/algorithmic structure 800 may further include, at 812, transmitting the configuration information to facilitate IUC in sidelink communications. The configuration information may be per-UE or per-resource pool configuration information that is transmitted by unicast or broadcast transmissions.

FIG. 9 illustrates a UE 900 in accordance with some aspects. The UE 900 may be a UE-A, a UE-B, or any other UE described in FIGS. 2, 3, or elsewhere herein.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), IoT devices, proximity sensors, vehicle-based UEs, infrastructure-based UEs.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, optical connection, etc. that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some aspects, the baseband processor circuitry 904A may access a communication protocol stack 936 in the memory/storage 912 to communicate over a 3GPP compatible network. In general, the baseband processor circuitry 904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some aspects, the PHY layer operations may additionally/alternatively be performed by the components of the RF interface circuitry 908.

The baseband processor circuitry 904A may generate or process baseband signals or waveforms that carry information in 3GPP-compatible networks. In some aspects, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein. The memory/storage 912 may also store configuration, resource pool, or IUC information as described elsewhere.

The memory/storage 912 include any type of volatile or non-volatile memory that may be distributed throughout the UE 900. In some aspects, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various aspects, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, phased array antennas, etc. The antenna 926 may have one or more panels designed for specific frequency bands including bands in frequency ranges 1 and 2.

The user interface circuitry 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays “LCDs,” LED displays, quantum dot displays, projectors, etc.), with the output of characters, graphics, or multimedia objects being generated or produced from the operation of the UE 900.

The sensors 920 may include devices, modules, or subsystems whose purpose is to detect events or changes in its environment and send the information (sensor data) about the detected events to some other device, module, subsystem, etc. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 922 may include software and hardware elements that operate to control particular devices that are embedded in the UE 900, attached to the UE 1100, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

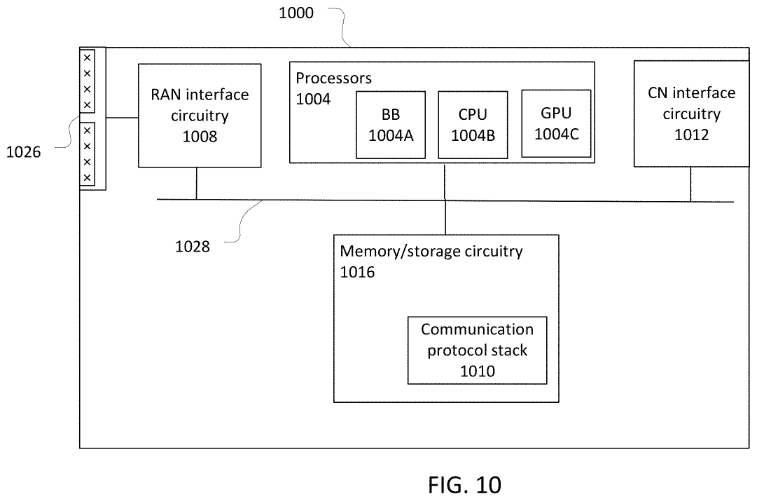

FIG. 10 illustrates a base station 1000 in accordance with some aspects. The gNB node 1000 may similar to and substantially interchangeable with base station 108.

The base station 1000 may include processors 1004, RF interface circuitry 1008, core network (CN) interface circuitry 1012, memory/storage circuitry 1016, and antenna structure 1026.

The components of the base station 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The CN interface circuitry 1012 may provide connectivity to a core network, for example, a 5^{th} Generation Core network (5GC) using a 5GC-compatible network interface protocol such as carrier Ethernet protocols, or some other suitable protocol. Network connectivity may be provided to/from the base station 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some aspects, the base station 1000 may be coupled with transmit receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a first user equipment (UE), the method comprising: accessing configuration information that configures the first UE with an inter-UE coordination (IUC) configuration to be used to avoid interference over a sidelink resource; detecting a sidelink resource conflict; and transmitting an IUC message to a second UE based on the IUC configuration and detecting the sidelink resource conflict.

Example 2 includes the method of example 1 or some other example herein, wherein the first or the second UE is configured to autonomously select sidelink resources from a resource pool for sidelink transmissions and the IUC configuration is configured for the resource pool.

Example 3 includes method of example 1 or some other example herein, further comprising: receiving the configuration information in a system information block (SIB) transmission or in dedicated radio resource control (RRC) message.

Example 4 includes the method of example 1 or some other example herein, further comprising: receiving the configuration information from a base station or the second UE.

Example 5 includes the method of example 1 or some other example herein, wherein the first UE comprises memory that is preconfigured with the configuration information and the method further comprises: accessing the configuration information from the memory; and transmitting the IUC message to the second UE while the first UE is operating outside-of-coverage.

Example 6 includes the method of example 1 or some other example herein, wherein the IUC configuration indicates an IUC scheme is enabled or disabled.

Example 7 includes the method of example 6 or some other example herein, wherein the IUC configuration indicates the IUC scheme is enabled and further indicates at least one option of the IUC scheme is allowed or blocked.

Example 8 includes a method of example 1 or some other example herein, wherein the configuration information is to configure at least one trigger for the IUC message, the at least one trigger to include detecting the sidelink resource conflict with at least a threshold confidence level.

Example 9 includes the method of example 1 or some other example herein, wherein the configuration information is to configure at least one trigger for the IUC message, the at least one trigger to include detecting the sidelink resource conflict due to a hybrid automatic repeat request (HARQ) retransmission or a scheduled periodic transmission.

Example 10 includes the method of example 1 or some other example herein, further comprising: transmitting an IUC capability of the first UE to a base station or a second UE.

Example 11 includes the method of example 1 or some other example herein, further comprising: transmitting an indication of a channel busy ratio (CBR) corresponding to the sidelink resource.

Example 12 includes a method of operating a base station, the method comprising: generating a message to include configuration information to configure a user equipment (UE) with one or more inter-UE coordination (IUC) configurations to be used to avoid interference over a sidelink resource; and transmitting the message to the UE.

Example 13 includes the method of example 12 or some other example herein, wherein the UE is configured for autonomous sidelink resource allocation.

Example 14 includes a method of example 13 or some other example herein, further comprising: transmitting the message to the UE in a system information block (SIB) or a dedicated radio resource control (RRC) message.

Example 15 includes method of example 13 or some other example herein, further comprising: transmitting the message to the UE when the UE is within coverage of the base station, wherein the UE is to utilize the one or more IUC configurations when the UE is out-of-coverage (OOC) of the base station.

Example 16 includes the method of example 12 or some other example herein, wherein the configuration information is specific to the UE or a sidelink resource pool.

Example 17 includes the method of example 12 or some other example herein, wherein the one or more IUC configurations include an IUC configuration indicates an IUC scheme is enabled or disabled.

Example 18 includes a method of example 17 or some other example herein, wherein the IUC configuration indicates the IUC scheme is enabled and further indicates at least one option of the IUC scheme is allowed or blocked.

Example 19 includes the method of example 12 or some other example herein, wherein the configuration information is to configure at least one trigger for an IUC message, the at least one trigger to include detecting a resource conflict with at least a threshold confidence level.

Example 20 includes the method of example 12 or some other example herein, wherein the configuration information is to configure at least one trigger for an IUC message, the at least one trigger to include detecting a resource conflict due to a hybrid automatic repeat request (HARQ) retransmission or a scheduled periodic transmission.

Example 21 includes a method of example 12 or some other example herein, further comprising: receiving a report of an IUC capability of the UE; and generating the configuration information based on the IUC capability.

Example 22 includes a method of example 21 or some other example herein, further comprising: receiving an indication of a channel busy ratio (CBR) corresponding to the sidelink resource; and generating the configuration information based further on the indication of the CBR.

Example 23 includes a method of operating a first user equipment (UE), the method comprising: determining an inter-UE coordination (IUC) capability of a second UE; transmitting, to the second UE, an IUC configuration message based on the IUC capability.

Example 24 includes the method of example 23 or some other example herein, wherein the IUC configuration message is to signal one or more IUC configurations to be used by the second UE.

Example 25 includes the method of example 23 or some other example herein, wherein the IUC configuration message is to signal one or more trigger conditions to trigger the second UE to transmit an IUC message.

Example 26 includes a method of example 25 or some other example herein, wherein the one or more trigger conditions comprise: receipt of an IUC request.

Example 27 includes the method of example 25 or some other example herein, wherein the one or more trigger conditions comprise detecting a resource conflict due to a hybrid automatic repeat request (HARQ) retransmission or a scheduled periodic transmission.

Example 28 includes the method of example 23 or some other example herein, wherein the IUC configuration message is to enable one or more IUC operational modes of the second UE.

Example 29 includes the method of example 28 or some other example herein, wherein the one or more IUC operational modes includes a victim-victim transmitter (VT) mode, a victim-interferer mode, a helper-interferer mode, or a helper-VT mode.

Example 30 includes a method of example 23 or some other example herein, further comprising: receiving, from the second UE, an IUC message that requests the first UE to yield use of a scheduled sidelink resource.

Example 31 includes a method comprising: receiving, from a user equipment (UE), an indication of one or more inter-UE coordination (IUC) statistics; generating configuration information based on the indication; and transmitting the configuration information to facilitate IUC in sidelink communication.

Example 32 includes the method of example 31 or some other example herein, wherein the one or more IUC statistics comprise: a number of half-duplex conflicts detected, a number of hidden-node conflicts detected, an average number of neighboring transmissions, a number of IUC messages detected, or an indication of physical sidelink feedback channel (PSFCH) usage for IUC information.

Example 33 includes method of example 31 or some other example herein, further comprising: receiving a radio resource control (RRC) message that includes the indication.

Example 34 includes the method of example 33 or some other example herein, wherein the RRC message comprises: a UE assistance information message or a measurement report message.

Example 35 may include an apparatus comprising means to perform one or more elements of a method described in or related to any of examples 1-34, or any other method or process described herein.

Example 36 may include one or more non-transitory computer-readable media comprising instructions to cause an electronic device, upon execution of the instructions by one or more processors of the electronic device, to perform one or more elements of a method described in or related to any of examples 1-34, or any other method or process described herein.

Example 37 may include an apparatus comprising logic, modules, or circuitry to perform one or more elements of a method described in or related to any of examples 1-34, or any other method or process described herein.

Example 38 may include a method, technique, or process as described in or related to any of examples 1-34, or portions or parts thereof.

Example 39 may include an apparatus comprising: one or more processors and one or more computer-readable media comprising instructions that, when executed by the one or more processors, cause the one or more processors to perform the method, techniques, or process as described in or related to any of examples 1-34, or portions thereof.

Example 40 may include a signal as described in or related to any of examples 1-34, or portions or parts thereof.

Example 41 may include a datagram, information element, packet, frame, segment, PDU, or message as described in or related to any of examples 1-34, or portions or parts thereof, or otherwise described in the present disclosure.

Example 42 may include a signal encoded with data as described in or related to any of examples 1-34, or portions or parts thereof, or otherwise described in the present disclosure.

Example 43 may include a signal encoded with a datagram, IE, packet, frame, segment, PDU, or message as described in or related to any of examples 1-34, or portions or parts thereof, or otherwise described in the present disclosure.

Example 44 may include an electromagnetic signal carrying computer-readable instructions, wherein execution of the computer-readable instructions by one or more processors is to cause the one or more processors to perform the method, techniques, or process as described in or related to any of examples 1-34, or portions thereof.

Example 45 may include a computer program comprising instructions, wherein execution of the program by a processing element is to cause the processing element to carry out the method, techniques, or process as described in or related to any of examples 1-34, or portions thereof.

Example 46 may include a signal in a wireless network as shown and described herein.

Example 47 may include a method of communicating in a wireless network as shown and described herein.

Example 48 may include a system for providing wireless communication as shown and described herein.

Example 49 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a base station, the method comprising:
generating a message to include configuration information to configure a user equipment (UE) with one or more inter-UE coordination (IUC) configurations to be used to avoid interference over a sidelink resource; and
transmitting the message to the UE.

2. The method of claim 1, further comprising:
receiving a report of an IUC capability of the UE; and
generating the configuration information based on the IUC capability.

3. The method of claim 1, wherein the configuration information is specific to a sidelink resource pool.

4. The method of claim 1, wherein the UE is configured for autonomous sidelink resource allocation.

5. The method of claim 1, further comprising:
transmitting the message to the UE in a radio resource control (RRC) message.

6. The method of claim 1, wherein the one or more IUC configurations include an IUC configuration that indicates an IUC scheme is enabled or and further indicates at least one option of the IUC scheme is allowed or blocked.

7. The method of claim 1, wherein the configuration information is to configure at least one trigger for an IUC message, the at least one trigger to include: detecting a resource conflict with at least a threshold confidence level; or detecting a resource conflict due to a hybrid automatic repeat request (HARQ) retransmission or a scheduled periodic transmission.

8. The method of claim 1, further comprising:
receiving an indication of a channel busy ratio (CBR) corresponding to the sidelink resource; and
generating the configuration information based further on the indication of the CBR.

9. One or more non-transitory, computer-readable media having instructions that, when executed by one or more processors, cause a first user equipment (UE) to:
receive, from a base station, configuration information that configures the first UE with an inter-UE coordination (IUC) configuration to be used to avoid interference over a sidelink resource;
detect a sidelink resource conflict; and
transmit an IUC message to a second UE based on the IUC configuration and the sidelink resource conflict.

10. The one or more non-transitory, computer-readable media of claim 9, wherein the first or the second UE is configured to autonomously select sidelink resources from a resource pool for sidelink transmissions and the IUC configuration is configured for the resource pool.

11. The one or more non-transitory, computer-readable media of claim 9, wherein the instructions, when executed, further cause the first UE to:
receive the configuration information in a radio resource control (RRC) message.

12. The one or more non-transitory, computer-readable media of claim 9, wherein the instructions, when executed, further cause the first UE to:
transmit an IUC capability of the first UE to the base station or a second UE.

13. The one or more non-transitory, computer-readable media of claim 9, wherein the IUC configuration indicates an IUC scheme is enabled and further indicates at least one option of the IUC scheme is allowed or blocked.

14. The one or more non-transitory, computer-readable media of claim 9, wherein the configuration information is to configure at least one trigger for the IUC message, the at least one trigger to include: detecting the sidelink resource conflict with at least a threshold confidence level; or detecting the sidelink resource conflict due to a hybrid automatic repeat request (HARQ) retransmission or a scheduled periodic transmission.

15. The one or more non-transitory, computer-readable media of claim 9, wherein the instructions, when executed, further cause the first UE to:
transmit an indication of a channel busy ratio (CBR) corresponding to the sidelink resource.

16. A first user equipment (UE) comprising:
radio-frequency (RF) interface circuitry; and
processing circuitry coupled with the RF interface circuitry, the processing circuitry to:
determine an inter-UE coordination (IUC) capability of a second UE; and
transmit, via the RF interface circuitry to the second UE, an IUC configuration message based on the IUC capability.

17. The first UE of claim 16, wherein the IUC configuration message is to signal one or more trigger conditions to trigger the second UE to transmit an IUC message.

18. The first UE of claim 17, wherein the one or more trigger conditions comprise: receipt of an IUC request; or detecting a resource conflict due to a hybrid automatic repeat request (HARQ) retransmission or a scheduled periodic transmission.

19. The first UE of claim 16, wherein the IUC configuration message is to enable one or more IUC operational modes of the second UE, the one or more IUC operational modes to include a victim-victim transmitter (VT) mode, a victim-interferer mode, a helper-interferer mode, or a helper-VT mode.

20. The first UE of claim 16, wherein the processing circuitry is further to:
receiving, via the RF interface circuitry from the second UE, an IUC message that requests the first UE to yield use of a scheduled sidelink resource.
